(19) United States
(12) Patent Application Publication
(10) Pub. No.: US 2024/0239314 A1
(43) Pub. Date: Jul. 18, 2024

(54) VEHICLE CONTROL APPARATUS

(71) Applicants: DENSO CORPORATION, Kariya-city (JP); TOYOTA JIDOSHA KABUSHIKI KAISHA, Toyota-shi (JP)

(72) Inventors: Tomohiko INOUE, Tokyo (JP); Youhei MASUI, Tokyo (JP); Takeshi INOGUCHI, Chiryu-shi (JP); Naoki KUSUMOTO, Okazaki-shi (JP)

(21) Appl. No.: 18/618,671

(22) Filed: Mar. 27, 2024

Related U.S. Application Data
(63) Continuation of application No. PCT/JP22/33907, filed on Sep. 9, 2022.

(30) Foreign Application Priority Data
Sep. 29, 2021 (JP) 2021-159875

(51) Int. Cl. B60T 7/22; B60T 17/22; B60W 30/16; G07C 5/08

(52) U.S. Cl. CPC B60T 7/22; B60T 17/22; G07C 5/0816; B60T 2210/32; B60W 30/16

(57) ABSTRACT

A vehicle control apparatus performs automatic braking control of a braking apparatus of a vehicle. The vehicle control apparatus determines durability of the braking apparatus and sets a control mode of automatic braking control to a restricted mode in which operation of the braking apparatus is restricted in response to determining that the durability of the braking apparatus has decreased. The restricted mode restricts execution of operation of the braking apparatus based on a generating factor for a deceleration request of the vehicle. The vehicle control apparatus determines whether to perform braking of the vehicle based on the deceleration request, based on the restricted mode and the generating factor for the deceleration request, in response to the deceleration request of the vehicle being generated.

### CROSS-REFERENCE TO RELATED APPLICATION

The present application is a continuation application of International Application No. PCT/JP2022/033907, filed on Sep. 9, 2022, which claims priority to Japanese Patent Application No. 2021-159875, filed on Sep. 29, 2021. The contents of these applications are incorporated herein by reference in their entirety.

### BACKGROUND

### Technical Field

The present disclosure relates to a vehicle control apparatus that automatically controls braking of a braking apparatus of a vehicle.

### Related Art

A vehicle control apparatus that provides a cruise control (CC) function is known. This vehicle control apparatus performs automatic braking control in which a braking apparatus is automatically operated, when maintaining speed of an own vehicle or performing control to follow a preceding vehicle.

### SUMMARY

One aspect of the present disclosure provides a vehicle control apparatus performs automatic braking control of a braking apparatus of a vehicle. The vehicle control apparatus determines durability of the braking apparatus and sets a control mode of automatic braking control to a restricted mode in which operation of the braking apparatus is restricted in response to determining that the durability of the braking apparatus has decreased. The restricted mode restricts execution of operation of the braking apparatus based on a generating factor for a deceleration request of the vehicle. The vehicle control apparatus determines whether to perform braking of the vehicle based on the deceleration request, based on the restricted mode and the generating factor for the deceleration request, in response to the deceleration request of the vehicle being generated.

### BRIEF DESCRIPTION OF THE DRAWINGS

In the accompanying drawings:

FIG. 1 is a block diagram illustrating an onboard system that includes a vehicle control apparatus according to a first embodiment;

FIG. 2 is a flowchart illustrating a vehicle control process performed by the vehicle control apparatus according to the first embodiment;

FIG. 3 is a flowchart illustrating a mode selection process shown in FIG. 2;

FIG. 4 is a flowchart illustrating a braking restriction determination process shown in FIG. 2;

FIG. 5 is a flowchart illustrating a vehicle control process performed by a vehicle control apparatus according to a second embodiment; and

FIG. 6 is a flowchart illustrating a restricted mode selection process shown in FIG. 5.

### DESCRIPTION OF THE EMBODIMENTS

A vehicle control apparatus that provides a cruise control (CC) function is known. For example, as described in JP 2000-085406 A, this vehicle control apparatus performs automatic braking control in which a braking apparatus is automatically operated, when maintaining speed of an own vehicle or performing control to follow a preceding vehicle.

As drive frequency and drive time of the braking apparatus increase as a result of the CC function for safe and comfortable travel, durability of the braking apparatus decreases and travel safety may instead be compromised.

It is thus desired to provide a vehicle braking apparatus that is highly safe and capable of implementing automatic braking control that takes into consideration durability of a braking apparatus.

A first exemplary embodiment of the present disclosure provides a vehicle control apparatuses that perform automatic braking control of a braking apparatus of a vehicle. This vehicle control apparatus of the first exemplary embodiment includes: a braking restriction determining unit that has a durability determining unit that determines durability of the braking apparatus and a mode setting unit that sets a control mode of automatic braking control to a restricted mode in which operation of the braking apparatus is restricted in response to the durability determining unit determining that the durability of the braking apparatus has decreased. The restricted mode restricts execution of operation of the braking apparatus based on a generating factor for a deceleration request of the vehicle. The braking restriction determining unit determines whether to perform braking of the vehicle based on the deceleration request, based on the restricted mode and the generating factor for the deceleration request, in response to the deceleration request of the vehicle being generated.

As a result of the vehicle control apparatus of the the first exemplary embodiment, when the durability of the braking apparatus is determined to have decreased, the control mode of automatic braking control is set to the restricted mode in which operation of the braking apparatus is restricted. The restricted mode restricts the execution of operation of the braking apparatus based on the generating factor for the deceleration request of the vehicle. The braking restriction determining unit determines whether to perform braking of the vehicle based on the deceleration request, based on the restricted mode that is set and the generating factor for the deceleration request. Therefore, automatic braking control can be implemented in which the braking apparatus can be operated with certainty when the generating factor for the deceleration request of the vehicle is content that highly necessitates operation of the braking apparatus, while decrease in the durability of the braking apparatus is suppressed by operation of the braking apparatus being restricted. As a result, the vehicle control apparatus that is highly safe and capable of implementing automatic braking control that takes into consideration the durability of the braking apparatus can be provided.

A second exemplary embodiment of the present disclosure provides a vehicle control apparatuses that perform automatic braking control of a braking apparatus of a vehicle. This vehicle control apparatus of the second exemplary embodiment includes a durability determining unit that determines durability of the braking apparatus. A driver of the vehicle is notified that the durability of the braking apparatus has decreased and the driver is suggested to stop the vehicle when the durability determining unit determines that the durability of the braking apparatus has decreased.

As a result of the vehicle control apparatus of the second exemplary embodiment, the driver is notified that the durability of the braking apparatus has decreased and is suggested to stop the vehicle when the durability of the braking apparatus is determined to have decreased. Safety of the vehicle can be ensured if the driver stops the vehicle before a deceleration request caused by a generating factor that highly necessitates operation of the braking apparatus is generated, as a result of the notification and suggestion. Consequently, the vehicle control apparatus that is highly safe and is capable of implementing automatic braking control that takes into consideration the durability of the braking apparatus can be provided.

A third exemplary embodiment of the present disclosure provides a vehicle control apparatus that performs automatic braking control of a braking apparatus of a vehicle. The vehicle control apparatus includes: a processor; a non-transitory computer-readable storage medium; and a set of computer-executable instructions stored on the computer-readable storage medium that, when read and executed by the processor, cause the processor to implement: determining durability of the braking apparatus; and setting a control mode of automatic braking control to a restricted mode in which operation of the braking apparatus is restricted in response to determining that the durability of the braking apparatus has decreased. The restricted mode restricts execution of operation of the braking apparatus based on a generating factor for a deceleration request of the vehicle. Determining the durability of the braking apparatus includes: determining whether to perform braking of the vehicle based on the deceleration request, based on the restricted mode and the generating factor for the deceleration request, in response to the deceleration request of the vehicle being generated.

A fourth exemplary embodiment of the present disclosure provides a vehicle control method for performing automatic braking control of a braking apparatus of a vehicle. The vehicle control method includes: determining durability of the braking apparatus; and setting a control mode of automatic braking control to a restricted mode in which operation of the braking apparatus is restricted in response to determining that the durability of the braking apparatus has decreased. The restricted mode restricts execution of operation of the braking apparatus based on a generating factor for a deceleration request of the vehicle. Determining the durability of the braking apparatus includes: determining whether to perform braking of the vehicle based on the deceleration request, based on the restricted mode and the generating factor for the deceleration request, in response to the deceleration request of the vehicle being generated.

The above-described exemplary embodiments of the present disclosure will be further clarified through the detailed description below, with reference to the accompanying drawings.

### First Embodiment

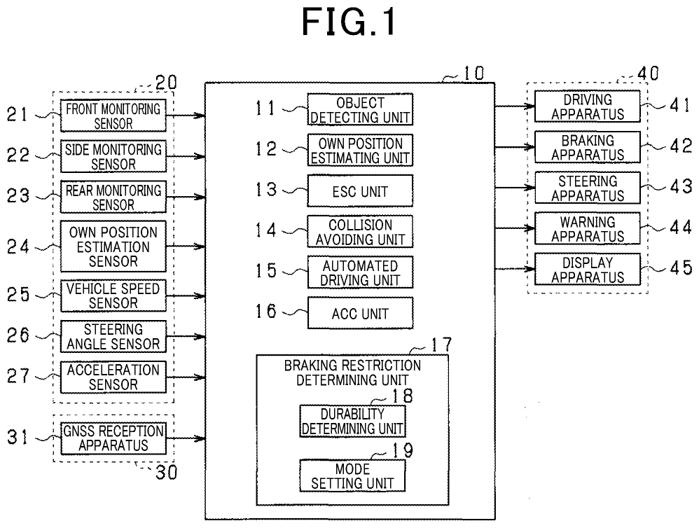

FIG. 1 shows an onboard system that includes a vehicle control apparatus 10 according to the present embodiment. The onboard system includes the vehicle control apparatus 10, sensors 20, a communication apparatus 30, and a controlled apparatus 40.

The sensors 20 include a front monitoring sensor 21, a side monitoring sensor 22, a rear monitoring sensor 23, an own position estimation sensor 24, a vehicle speed sensor 25, a steering angle sensor 26, and an acceleration sensor 27. Information acquired by the sensors 20 is inputted to the vehicle control apparatus 10.

The front monitoring sensor 21, the side monitoring sensor 22, and the rear monitoring sensor 23 are peripheral monitoring sensors that respectively monitor the front, side, and rear of an own vehicle. Image sensors, radio radars, laser radars, and ultrasonic sensors can be suitably used as the front monitoring sensor 21, the side monitoring sensor 22, and the rear monitoring sensor 23.

The image sensor is configured by a charge-coupled device (CCD) camera, a complementary metal-oxide semiconductor (CMOS) image sensor, a near-infrared camera, or the like. Here, the image sensor may be a monocular camera or a stereo camera. When cameras are used as the front monitoring sensor 21, the side monitoring sensor 22, and the rear monitoring sensor 23, front and rear cameras are respectively attached at a predetermined height in the center in a vehicle width direction of the own vehicle, such as near an upper end of a front windshield and near an upper end of a rear windshield. The front camera and the rear camera capture areas spread over predetermined angular ranges ahead of the own vehicle and behind the own vehicle. Side cameras are attached to both sides in left and right directions of the own vehicle, such as near front doors or rear doors. The side cameras capture areas spread over predetermined angular ranges toward both sides in the left and right directions of the own vehicle.

The radio radar is capable of detecting presence/absence of an object in the vicinity of the own vehicle, a distance between the object and the own vehicle, a position, size, and shape of the object, a relative speed of the object to the own vehicle, and the like by detecting reflected waves of irradiated radio waves. The laser radar is capable of detecting the presence/absence of an object in the vicinity of the own vehicle and the like in a manner similar to the radio radar through use of infrared laser light. The ultrasonic sensor is capable of detecting the distance between the own vehicle and an object in the vicinity of the own vehicle and the like in a manner similar to the radio radar through use of ultrasonic waves. These radar sensors are attached to a front end portion, a rear end portion, and side end portions of the own vehicle. The radar sensor scans an area surrounding the own vehicle by radar signals every predetermined amount of time and receives electromagnetic waves reflected by a surface of an object present in the vicinity of the own vehicle. The radar sensor thereby acquires the distance to the object, the relative speed to the object, and the like as object information and inputs the object information to the vehicle control apparatus 10. If the object is a preceding vehicle, an inter-vehicle distance between the own vehicle and the preceding vehicle, the relative speed to the preceding vehicle, a relative acceleration to the preceding vehicle, and the like are inputted to the vehicle control apparatus 10 as preceding vehicle information.

A gyro sensor, a yaw rate sensor, and the like can be given as examples of the own position estimation sensor 24. The gyro sensor detects a rotation angle around three orthogonal axes defined with the own vehicle as the center, and outputs a rotation angle signal to the vehicle control apparatus 10. Only one or a plurality of yaw rate sensors may set. When only one is set, for example, the yaw rate sensor is provided in a center position of the own vehicle. The yaw rate sensor outputs, to the vehicle control apparatus 10, a yaw rate signal based on a speed of change in steering amount of the own vehicle.

The vehicle speed sensor 25 is a sensor that detects a traveling speed of the own vehicle. Although the vehicle speed sensor 25 is not limited, for example, a wheel speed sensor that is capable of detecting a rotation speed of a wheel can be used. For example, the wheel speed sensor used as the vehicle speed sensor 25 is attached to a wheel portion of the wheel and outputs, to the vehicle control apparatus 10, a wheel speed signal based on a wheel speed of the own vehicle.

For example, the steering angle sensor 26 is attached to a steering rod of the vehicle and outputs, to the vehicle control apparatus 10, a steering angle signal based on changes in steering angle of a steering wheel accompanying operations by a driver. The gyro sensor detects the rotation angle around three orthogonal axes defined with the own vehicle at the center and outputs the rotation angle signal to the vehicle control apparatus 10.

The acceleration sensor 27 detects acceleration around three orthogonal axes defined with the own vehicle at the center and outputs an acceleration signal to the vehicle control apparatus 10. The acceleration sensor 27 may be referred to as a G sensor.

The communication apparatus 30 includes a global navigation satellite system (GNSS) reception apparatus 31. The GNSS reception apparatus 31 receives a positioning signal from a satellite positioning system that determines a current position on the ground by artificial satellites and estimates an own position, that is, a current position (longitude and latitude) of the own vehicle based on the positioning signal. The GNSS reception apparatus 31 is capable of receiving the positioning signal at every predetermined cycle. The own position can be successively estimated by the positioning signal being successively received. The communication apparatus 30 may include a communication apparatus other than the GNSS reception apparatus. Although not shown, for example, the communication apparatus 30 may include a wireless communication apparatus or the like. The wireless communication apparatus performs wireless communication with an advanced road traffic system, inter-vehicle communication with another vehicle, and road-vehicle communication with a roadside radio set in road equipment. As a result, status information related to a state of the own vehicle and a state of the surroundings can be exchanged.

The controlled apparatus 40 includes a drive apparatus 41, a braking apparatus 42, a steering apparatus 43, a warning apparatus 44, and a display apparatus 45. The controlled apparatus 40 is configured to be operated based on control commands from the vehicle control apparatus 10 and operated by operation input from the driver. Here, operation input from the driver may be inputted to the controlled apparatus 40 as the control command after being appropriately processed by the vehicle control apparatus 10.

The drive apparatus 41 is an apparatus for driving the vehicle and is controlled by operation of an accelerator and the like by the driver or commands from the vehicle control apparatus 10. Specifically, a drive source of the vehicle, such as an internal combustion engine, a motor, or a storage battery, and various configurations related to the drive source can be given as the drive apparatus 41. The vehicle control apparatus 10 provides a function for automatically controlling the drive apparatus 41 based on a travel plan or a vehicle state of the own vehicle.

The braking apparatus 42 is an apparatus for braking the own vehicle and is configured by an apparatus group (actuator) related to brake control such as a sensor, a motor, a valve, a pump, and the like. The braking apparatus 42 is controlled by brake operations by the driver or commands from the vehicle control apparatus 10. The vehicle control apparatus 10 determines a timing at which brakes are applied and a brake amount (braking amount), and controls the braking apparatus 42 so that the determined brake amount is achieved at the determined timing.

The steering apparatus 43 is an apparatus for steering the own vehicle and is controlled by steering operations by the driver or commands from the vehicle control apparatus 10. The vehicle control apparatus 10 provides a function for automatically controlling the steering apparatus 43 to avoid collisions or change traffic lanes.

The warning apparatus 44 is an apparatus for audibly notifying the driver and the like and, for example, is a speaker, a buzzer, or the like set in a vehicle cabin of the own vehicle. For example, the warning apparatus 44 notifies the driver of a risk of collision with an object by generating a warning sound or the like based on a control command from the vehicle control apparatus 10.

The display apparatus 45 is an apparatus for visually notifying the driver and the like and, for example, is a display, a gauge, or the like set in the vehicle cabin of the own vehicle. For example, the display apparatus 45 notifies the driver of a risk of collision with an object by displaying a warning message or the like based on a control command from the vehicle control apparatus 10.

The controlled apparatus 40 may include apparatuses that are controlled by the vehicle control apparatus 10 other than those described above. For example, the controlled apparatus 40 may include a safety apparatus for ensuring safety of the driver. Specifically, as the safety apparatus, a seatbelt apparatus that provides a pre-tensioner mechanism that draws in the seatbelt provided for each seat in the own vehicle can be given as an example. In addition, the safety apparatus may include a vibration apparatus that alerts the driver by vibrating a seat or the like.

The vehicle control apparatus 10 provides an adaptive cruise control (ACC) function for controlling the traveling speed of the own vehicle to maintain a target inter-vehicle distance to the preceding vehicle by adjusting drive force and braking force, an electronic stability control (ESC) function for stabilizing vehicle behavior by preventing lateral sliding of the own vehicle, a function as a pre-crash safety (PCS) system that determines whether a collision of the own vehicle with an object positioned in the vicinity of the own vehicle will occur and performs control to avoid the collision with the object or mitigate collision damage, a lane keeping assist (LKA) function for making the vehicle travel so as to keep to the traffic lane being traveled by generating steering force in a direction inhibiting approach toward a traveling lane marker, a lane change assist (LCA) function for automatically moving the vehicle to an adjacent traffic lane, and the like.

The vehicle control apparatus 10 includes an object detecting unit 11, an own position estimating unit 12, an ESC unit 13, a collision avoiding unit 14, an automated driving unit 15, an ACC unit 16, and a braking restriction determining unit 17. The vehicle control apparatus 10 is an electronic control unit (ECU) and includes a known microcomputer that is composed of a central processing unit (CPU), a read-only memory (ROM), a random access memory (RAM), a flash memory, and the like. Functions of each section provided in the vehicle control apparatus 10 are implemented by the CPU running a program installed in the ROM. As a result, the vehicle control apparatus 10 functions as a vehicle control apparatus that is capable of performing ACC, ESC, PCS, LKA, LCA, and the like by performing driving assistance of the own vehicle by outputting control requests to the controlled apparatuses 40 based on information acquired from the sensors 20 and the communication apparatus 30.

The object detecting unit 11 detects objects in the vicinity of the own vehicle based on the object information acquired from the front monitoring sensor 21, the side monitoring sensors 22, and the rear monitoring sensor 23. For example, the object detecting unit 11 calculates a relative position, an area of presence, and the like of the object based on the distance to the object and an orientation of the object calculated from an image acquired from an image sensor, and acquires these pieces of information as image information. The object detecting unit 11 calculates the relative position, the area of presence, and the like of the object based on the distance to the object and the orientation of the object included in distance information acquired from the radar sensor, and acquires these pieces of information as radar information. The object detecting unit 11 fuses the image information and the radar information and recognizes the object. More specifically, when an overlapping portion is present between the area of presence of the object included in the image information and the area of presence of the object included in the radar information, the object is recognized. As a result of the object detecting unit 11, moving objects such as vehicles and pedestrians in the vicinity of the own vehicle, white lane markers on a road surface, information on red lights of traffic lights at intersections, traffic signs for pedestrian crossings, speed limits, and the like, and various signs on the road surface can be detected.

The own position estimating unit 12 estimates a current or future position of the own vehicle based on information acquired from the sensors 20. The future position of the own vehicle may be estimated based on the current position of the own vehicle or may be estimated based on the travel plan of the vehicle control apparatus 10. The own position estimating unit 12 may be capable of estimating the speed, acceleration, rotation speed, and the like in addition to the current or future position of the own vehicle. A prediction model for predicting various parameters regarding the own vehicle described above is not particularly limited. However, a constant speed and constant acceleration model that presumes a constant speed and a constant acceleration, a constant steering angle model that presumes a constant steering angle, a constant rotation speed model that presumes a constant rotation speed, or the like can be used.

The ESC unit 13 performs calculation for stabilizing vehicle behavior based on the information outputted from the own position estimation sensor 24, the vehicle speed sensor 25, and the acceleration sensor 27 and outputs, to the drive apparatus 41 and the braking apparatus 42, signals for adjusting the speed of the vehicle based on the calculation results.

The collision avoiding unit 14 provides a function as the PCS system that determines whether a collision of the own vehicle with an object that is positioned in the vicinity of the own vehicle and detected by the object detecting unit 11 will occur, and performs control to avoid the collision with the object or mitigate collision damage. Specifically, the collision avoiding unit 14 calculates a predicted collision time (time to collision [TTC]) that is an amount of time until the own vehicle and the object collide based on the relative distance between the own vehicle and the object, and determines whether to operate the brake apparatus 51, the steering apparatus 43, the warning apparatus 44, and the like based on a comparison between the predicted collision time and an operation timing. Here, the operation timing is timing at which the braking apparatus 42 and the like are to be operated. The operation timing may be set for each subject to be operated. In addition, the predicted collision time is calculated based on the current position and the future position of the own vehicle estimated by the own position estimating unit 12.

The automated driving unit 15 is configured to be capable of performing automated driving and autonomous parking based on the travel plan and the like. For example, the automated driving unit 15 may provide the LKA function for making the vehicle travel so as to keep to the traffic lane being traveled by generating steering force in a direction inhibiting approach toward a traveling lane marker, the LCA function for automatically moving the vehicle to an adjacent traffic lane, and the like.

The ACC unit 16 is configured to provide the ACC function for controlling the traveling speed of the own vehicle to maintain the target inter-vehicle distance to the preceding vehicle by adjusting drive force and braking force.

The braking restriction determining unit 17 includes a durability determining unit 18 and a mode setting unit 19.

The durability determining unit 18 determines whether durability of the braking apparatus 42 has decreased based on a durability parameter that affects the durability of the braking apparatus 42. As the durability parameter, a temperature, an operation time, an operation frequency, an applied current, an applied voltage, and the like of the braking apparatus 42 can be given as examples.

The durability determining unit 18 determines whether durability has decreased based on a comparison to a predetermined durability evaluation threshold set for the parameter. The durability determining unit 18 may be configured to be capable of setting a plurality of durability evaluation thresholds in stages for a single parameter and evaluating a degree of decrease in durability based on comparisons to the plurality of durability evaluation thresholds.

For example, regarding the durability parameter, the durability can be determined to have decreased as the temperature of the braking apparatus 42 increases. Therefore, temperature thresholds serving as the durability evaluation thresholds may be set in stages, and the durability of the braking apparatus 42 may be determined to have decreased as the temperature of the braking apparatus 42 becomes equal to or greater than temperature thresholds of higher temperatures.

In addition, the durability can be determined to have decreased as the operation time of the braking apparatus 42 increases. Therefore, time thresholds serving as the durability evaluation thresholds may be set in stages, and the durability of the braking apparatus 42 may be determined to have decreased as the operation time of the braking apparatus 42 becomes equal to or greater than time thresholds of longer amounts of time.

Furthermore, the durability can be determined to have decreased as the operation frequency of the braking apparatus 42 increases. Therefore, frequency thresholds serving as the durability evaluation thresholds may be set in stages, and the durability of the braking apparatus 42 may be determined to have decreased as the operation frequency of the braking apparatus 42 becomes equal to or greater than frequency thresholds of greater frequencies.

In addition, the durability can be determined to have decreased as the applied current of the braking apparatus 42 increases. Therefore, current thresholds serving as the durability evaluation thresholds may be set in stages, and the durability of the braking apparatus 42 may be determined to have decreased as the applied current of the braking apparatus 42 becomes equal to or greater than current thresholds of higher currents.

Furthermore, the durability can be determined to have decreased as the applied voltage of the braking apparatus 42 increases. Therefore, voltage thresholds serving as the durability evaluation thresholds may be set in stages, and the durability of the braking apparatus 42 may be determined to have decreased as the applied voltage of the braking apparatus 42 becomes equal to or greater than voltage thresholds of higher voltages.

When evaluation is performed using a plurality of durability parameters, the durability of the braking apparatus 42 may be evaluated based on the parameter by which the evaluation indicates the greatest degree of decrease in durability. Alternatively, the durability of the braking apparatus 42 may be evaluated in an integrated manner based on the degrees of decrease in durability based on a plurality of parameters.

The mode setting unit 19 sets a control mode to normal mode or restricted mode. The normal mode is a normal control mode in which execution of operation of the braking apparatus 42 is not restricted. The restricted mode is a control mode in which execution of operation of the braking apparatus 42 is restricted based on a generating factor for a deceleration request of the vehicle. As a method for restricting the execution of operation of the braking apparatus 42, a method that reduces decrease in durability of the braking apparatus 42 can be used. Specifically, non-use of automatic braking, intermittent braking, use of engine brakes, change to a lower gear, and the like can be given as examples.

In the restricted mode, generating factors that restrict operation of the braking apparatus 42 and generating factors that do not restrict operation of the braking apparatus 42 are set. As the generating factors for the deceleration request, factors 1 to 9, below, can be given as examples. The deceleration request is preferably a deceleration request for which at least any one of factors 1 to 9 is the generating factor.

(Factor 1) Avoid or mitigate a collision with an obstacle ahead of the vehicle.

(Factor 2) Avoid or mitigate collisions with a preceding vehicle and an adjacent vehicle of the vehicle.

(Factor 3) Avoid or mitigate a collision with a pedestrian.

(Factor 4) Avoid or mitigate a collision on a curved road.

(Factor 5) Maintain inter-vehicle distances to a preceding vehicle and an adjacent vehicle of the vehicle.

(Factor 6) Stop or reduce vehicle speed in response to a stop instruction from a traffic signal.

(Factor 7) Accommodate a vehicle speed on a regulatory sign or stop in response to a speed regulatory sign or a stop instruction sign.

(Factor 8) Reduce vehicle speed in response to a downhill road or road surface conditions.

(Factor 9) Reduce vehicle speed in response to vehicle speed control by the CC function.

The deceleration request based on the above-described factors may be generated from configurations that are involved in the execution of driving assistance included in the vehicle control apparatus 10. For example, factors 1 to 4 are generated as the deceleration request from the collision avoiding unit 14. Factors 5 and 6 are generated as the deceleration request from the ACC unit 16. Factors 7 and 9 are generated as the deceleration request from the automated driving unit 15. Factor 8 is generated as the deceleration request from the ESC unit 13.

The restricted mode set by the mode setting unit 19 may be one or plural. A plurality of restricted modes have differing combinations of the generating factors that restrict operation of the braking apparatus 42 and the generating factors that do not restrict operation of the braking apparatus 42. That is, correspondence between the generating factors for the deceleration request of the vehicle and whether operation of the braking apparatus 42 can be performed differs.

For example, in a plurality of restricted modes 1 to 3 corresponding to factors 2 to 5 and 9, in the restricted mode 1, the generating factor that restricts the operation of the braking apparatus 42 is factor 9, and the generating factors that do not restrict the operation of the braking apparatus 42 are factors 2 to 5. In the restricted mode 2, the generating factors that restrict the operation of the braking apparatus 42 are factors 5 and 9, and the generating factors that do not restrict the operation of the braking apparatus 42 are factors 2 to 4. In the restricted mode 3, the generating factors that restrict the operation of the braking apparatus 42 are factors 4, 5, and 9, and the generating factors that do not restrict the operation of the braking apparatus 42 are factors 2 and 3.

The restricted modes 1, 2, and 3 have a greater number of generating factors restricting the operation of the braking apparatus 42 in this order and can be said to have stricter restrictions in this order. In addition, operation of the braking apparatus 42 is unrestricted even in stricter restricted modes, as the generating factor becomes that which has a greater risk of leading to collisions and accidents, among the generating factors.

The mode setting unit 19 may be configured to set a restricted mode that is selected from a plurality of restricted modes based on a comparison between a predetermined parameter that affects the durability of the braking apparatus 42 and a predetermined mode setting threshold that is set for the parameter. In a manner similar to the durability threshold, the mode setting threshold is preferably a value by which a stricter restricted mode is set as a condition that causes the degree of decrease in the durability of the braking apparatus 42 to become more serious is met.

For example, when the durability parameter is temperature T of the braking apparatus 42, as the mode setting threshold, temperature thresholds T1, T2, and T3 may be set in stages to be T1<T2<T3. Then, based on comparisons between the temperature T and the temperature thresholds T1 to T3, the normal mode may be set when T<T1. The restricted mode 1 may be set when T1≤T<T2. The restricted mode 2 may be set when T2≤T<T3. The restricted mode 3 may be set when T3≤T.

When mode setting is performed using a plurality of durability parameters, the durability parameters and the mode setting thresholds are preferably individually compared. The strictest restricted mode among the selected restricted modes is preferably set as the control mode.

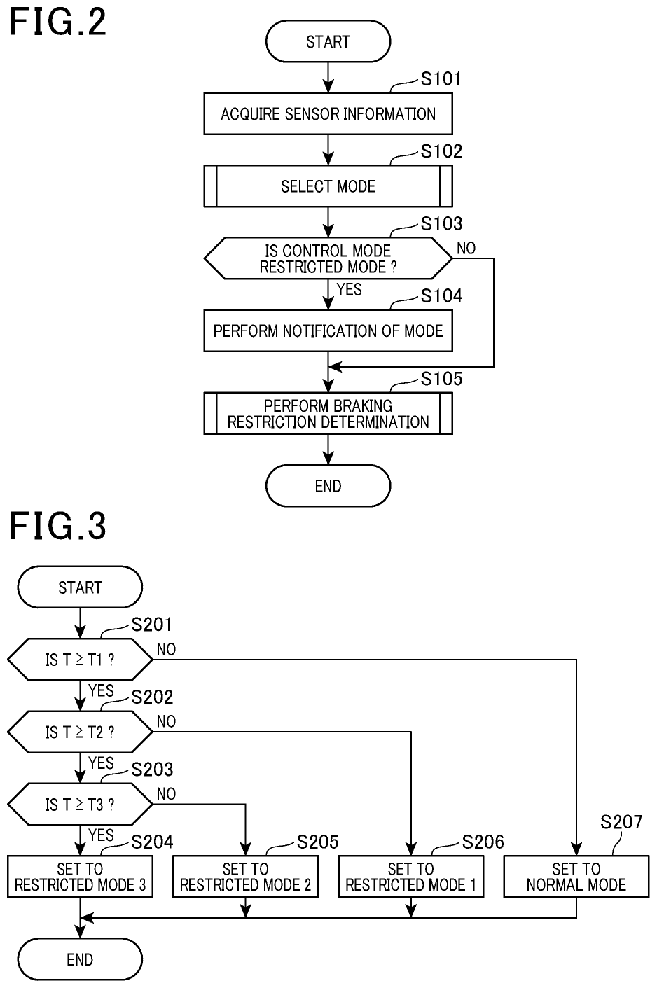

FIG. 2 shows a flowchart of a vehicle control process performed by the vehicle control apparatus 10. The process shown in FIG. 2 is repeatedly performed by the vehicle control apparatus 10 at a predetermined cycle.

At step S101, the sensor information is acquired from the sensors 20. Subsequently, the process proceeds to step S102. At step S102, the control mode for automatic braking control is selected and set. The control mode includes the restricted modes in which operation of the braking apparatus 42 is restricted and the normal mode in which the operation of the braking apparatus 42 is not restricted.

FIG. 3 shows a flowchart of a mode selection process. At step S201, a case in which the durability parameter is the temperature T of the braking apparatus 42 is described as an example. As the mode setting threshold, the temperature thresholds T1, T2, and T3 are set in stages to be T1<T2<T3.

At step S201, whether the temperature T of the braking apparatus 42 is equal to or greater than the lowest temperature threshold T1 is determined. When T≥T1, the process proceeds to step S202. When T<T1, the process proceeds to step S207, and the normal mode is selected and set.

At step S202, whether the temperature T of the braking apparatus 42 is equal to or greater than the intermediate temperature threshold T2 is determined. When T≥T2, the process proceeds to step S203. When T<T2, the process proceeds to step S206, and the restricted mode 1 is selected and set.

At step S203, whether the temperature T of the braking apparatus 42 is equal to or greater than the highest temperature threshold T3 is determined. When T≥T3, the process proceeds to step S204, and the restricted mode 3 is selected and set. When T<T3, the process proceeds to step S205, and the restricted mode 2 is selected and set. As a result of the series of processes shown in FIG. 3, one of the restricted modes 1 to 3 or the normal mode is selected and set as the control mode. Subsequently, the process proceeds to step S103.

At step S103, whether the control mode that is set is one of the restricted modes is determined. When one of the restricted modes 1 to 3 is set at step S102, an affirmative determination is made. The process proceeds to step S104. When the normal mode is set at step S102, a negative determination is made. The process proceeds to step S105.

At step S104, the driver is notified that one of the restricted modes is set. The notification is performed by any of sound, display, and vibrations. For example, the driver is notified of the restricted mode by an instruction to issue a notification being outputted to the warning apparatus 44 or the display apparatus 45. Subsequently, the process proceeds to step S105.

At step S105, when a deceleration request of the vehicle is issued, a braking restriction determination process for determining whether to perform braking of the vehicle based on the deceleration request is performed based on the restricted mode and the generating factors for the deceleration request.

Here, in the present flowchart, the description is given such that, in the above-described restricted modes 1 to 3, “a generating factor that restricts operation of the braking apparatus 42” is replaced by “a generating factor that uses automatic braking” and “a generating factor that does not restrict operation of the braking apparatus” is replaced by “a generating factor that uses automatic braking.” In the restricted mode 1, the generating factor that does not use automatic braking is factor 9, and the generating factors that use the automatic braking is factors 2 to 5. In the restricted mode 2, the generating factors that do not use automatic braking are factors 5 and 9, and the generating factors that use automatic braking are factors 2 to 4. In the restricted mode 3, the generating factors that do not use automatic braking are factors 4, 5, and 9, and the generating factors that use automatic braking are factors 2 and 3.

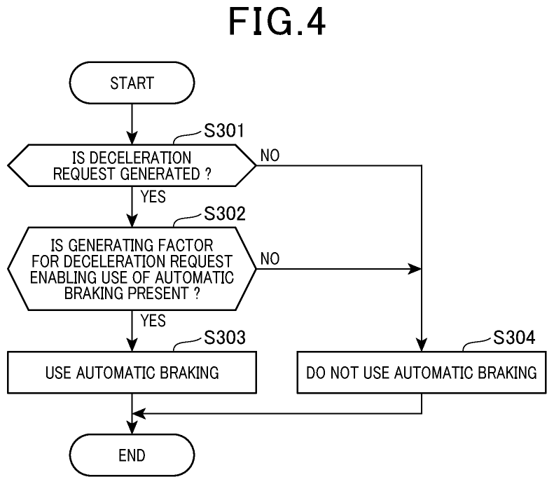

FIG. 4 shows a flowchart of the braking restriction determination process. At step S301, whether the deceleration request is generated is determined. When the deceleration request is generated, the process proceeds to step S302. When the deceleration request is not generated, the process proceeds to step S304 and a determination that automatic braking is not to be used is made.

At step S302, whether at least one of the generating factors for the deceleration request at step S301 corresponds to the generating factor that uses automatic braking in the control mode set at step S102 in FIG. 2 is determined.

For example, when the normal mode is selected and the generating factors are factors 2 to 5 and 9, an affirmative determination is made at step S302. When the restricted mode 1 is selected and the generating factors are factors 2 to 5, an affirmative determination is made at step S302. When the restricted mode 2 is selected and the generating factors are factors 2 to 4, an affirmative determination is made at step S302. When the restricted mode is 3 and the generating factors are factors 2 and 3, an affirmative determination is made at step S302.

When the restricted mode 1 is selected and the generated deceleration request is factor 9, a negative determination is made at step S302. When the restricted mode 2 is selected and the generated deceleration request is factors 5 and 9, a negative determination is made at step S302. When the restricted mode 3 is selected and the generated deceleration request is factors 4, 5, and 9, a negative determination is made at step S302.

Here, when “a generating factor that uses automatic braking” and “a generating factor that does not use automatic braking” are both included in the set restricted mode, an affirmative determination is made at step S302. For example, when the restricted mode 3 is selected and the generated deceleration request is factors 2, 5, and 9, an affirmative determination is made at step S302.

When an affirmative determination is made at step S302, the process proceeds to step S303 and a determination that automatic braking is to be used is made. When a negative determination is made, the process proceeds to step S304 and a determination that automatic braking is not to be used is made. When the determination that automatic braking is to be used is made, an operation command to use automatic braking is outputted to the braking apparatus 42 in adherence to the deceleration request generated at step S301. When the determination that automatic braking is not to be used is made, an operation command to not use automatic braking is outputted to the braking apparatus 42 (or an operation command is not outputted) without adherence to the deceleration request generated at step S301. As a result of the series of processes shown in FIG. 4, use or non-use of the automatic braking is determined. After a command based on this determination is outputted to the braking apparatus 42, the process is ended.

As a result of the vehicle control apparatus 10 according to the first embodiment, as indicated at steps S102 and S201 to S207, when the durability of the braking apparatus 42 is determined to have decreased, the control mode for automatic braking control is set to one of the restricted modes 1 to 3 that restricts operation of the braking apparatus 42. The restricted modes 103 are set to content that restricts the execution of operation of the braking apparatus 42 based on the generating factors for the deceleration request of the vehicle. Furthermore, as indicated at steps S105 and S301 to S304, whether to perform braking of the vehicle based on the deceleration request is determined based on the control mode (the normal mode or one of the restricted modes 1 to 3) that is set and the generating factors for the deceleration request. As a result, automatic braking control can be implemented in which the braking apparatus 42 can be operated with certainty when the generating factor for the deceleration request of the vehicle is content that highly necessitates operation of the braking apparatus 42, such as factors 2 and 3, while decrease in the durability of the braking apparatus 42 is suppressed by operation of the braking apparatus 42 being restricted. Consequently, automatic braking control that takes into consideration the durability of the braking apparatus 42 can be implemented.

### Second Embodiment

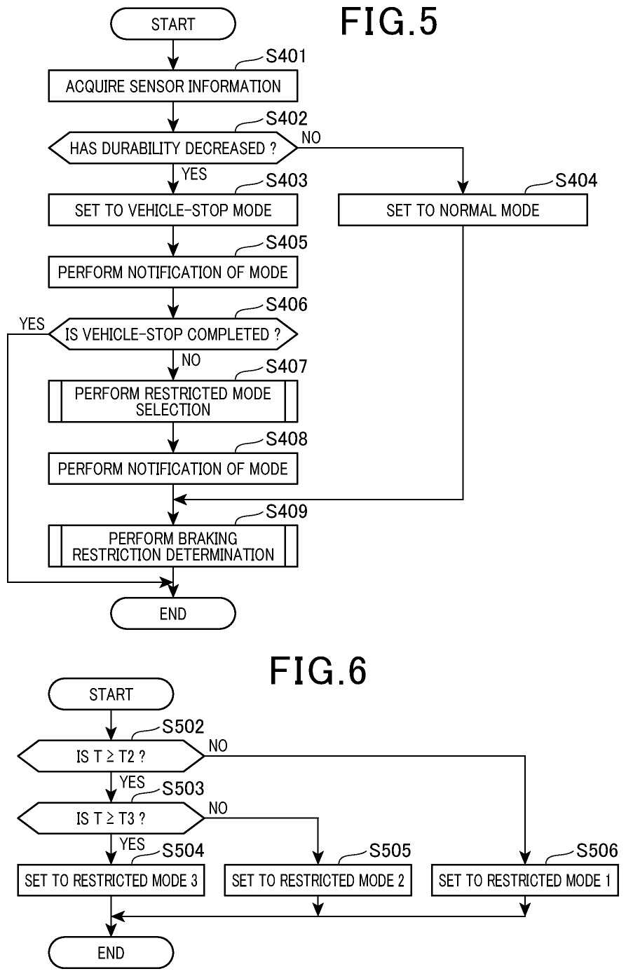

FIG. 5 shows a flowchart of a vehicle control process according to a second embodiment. The vehicle control process shown in FIG. 5 can be implemented by a configuration similar to the vehicle control apparatus 10 shown in FIG. 1 and the onboard system including the vehicle control apparatus 10. The process shown in FIG. 5 is repeatedly performed by the vehicle control apparatus 10 at a predetermined cycle.

At step S401, the sensor information is acquired from the sensors 20. Subsequently, the process proceeds to step S402.

At step S402, whether the durability of the braking apparatus 42 has decreased is determined. Specifically, whether the durability has decreased is determined based on a comparison between the durability parameter and the durability evaluation threshold. More specifically, when described using an example in which the durability parameter is the temperature T of the braking apparatus 42, the durability evaluation threshold is set to T1, and whether the temperature T of the braking apparatus 42 is equal to or greater than the lowest temperature threshold T1 is determined. When T≥T1, the process proceeds to step S403. After a vehicle-stop mode is selected, the process proceeds to step S405. When T<T1, the process proceeds to step S404. After the normal mode is selected, the process proceeds to step S409.

At step S405, the driver is notified that the durability of the braking apparatus 42 has decreased and the vehicle-stop mode is selected. In addition, the driver is suggested to stop the vehicle. The notification and suggestion are implemented by any of sound, display, and vibrations. An instruction to issue the notification is outputted to the warning apparatus 44 and the display apparatus 45. Subsequently, the process proceeds to step S406.

At step S406, whether vehicle-stop is completed is determined. When vehicle-stopp is completed, the process is ended. When vehicle-stop is not completed, the process proceeds to step S407.

At step S407, a process to select the restricted mode is performed. FIG. 6 shows a flowchart of a restricted mode selection process. The process shown in FIG. 6 is similar to a process in which the process at step S201 is eliminated from the processes shown in FIG. 3.

At step S502, whether the temperature T of the braking apparatus 42 is equal to or greater than the intermediate temperature threshold T2 is determined. When T≥T2, the process proceeds to step S503. When T<T2, the process proceeds to step S506, and the restricted mode 1 is selected and set. At step S503, whether the temperature T of the braking apparatus 42 is equal to or greater than the highest temperature threshold T3 is determined. When T≥T3, the process proceeds to step S504, and the restricted mode 3 is selected and set. When T<T3, the process proceeds to step S505, and the restricted mode 2 is selected and set. As a result of the series of processes shown in FIG. 5, one of the restricted modes 1 to 3 is selected and set as the control mode. Subsequently, the process proceeds to step S408.

At step S408, the driver is notified that the restricted mode is set. In a manner similar to that at step S104 in FIG. 2, the notification is performed by any of sound, display, and vibrations. Subsequently, the process proceeds to step S409.

At step S409, in a manner similar to that at step S105 in FIG. 2 and steps S301 to S304 in FIG. 4, when the deceleration request of the vehicle is generated, the braking restriction determination process for determining whether to perform braking of the vehicle based on the deceleration request is performed based on the restricted mode and the generating factors for the deceleration request. As a result of the series of processes shown in FIG. 4, use or non-use of automatic braking is determined, and a command based on the determination is outputted to the braking apparatus 42. Subsequently, the process shown in FIG. 5 is ended.

As a result of the vehicle control apparatus 10 according to the second embodiment, as indicated at steps S402, S403, and S405, when the durability of the braking apparatus 42 is determined to have decreased, the driver is notified that the durability of the braking apparatus 42 has decreased and is suggested to stop the vehicle. Safety of the vehicle can be ensured if the driver stops the vehicle before the deceleration request caused by a generating factor that highly necessitates operation of the braking apparatus 42 is generated.

When the driver does not stop the vehicle even as a result of the notification and suggestion, as indicated at steps S406 to S409, the restricted mode is set and brake control determination is performed. According to the second embodiment, automatic braking control can be implemented in which the braking apparatus 42 can be operated with certainty when the generating factor for the deceleration request of the vehicle is content that highly necessitates operation of the braking apparatus 42, while priority is given to the driver stopping the vehicle before the deceleration request caused by the generating factor that highly necessitates operation of the braking apparatus 42 is generated and, when the vehicle cannot be stopped, decrease in the durability of the braking apparatus 42 is suppressed by operation of the braking apparatus 42 being restricted by the restricted mode being set and braking restriction determination being performed.

According to the embodiments described above, the following effects can be achieved.

The vehicle control apparatus 10 is configured to be capable of performing automatic braking control of the braking apparatus 42 of a vehicle. The vehicle control apparatus 10 includes the braking restriction determining unit 17 that includes the durability determining unit 18 and the mode setting unit 19. The durability determining unit 18 determines the durability of the braking apparatus 42. The mode setting unit 19 sets the control mode of automatic braking control to the restricted mode (such as one of the restricted modes 1 to 3) in which operation of the braking apparatus 42 is restricted when the durability determining unit 18 determines that the durability of the braking apparatus 42 has decreased. The restricted mode restricts the execution of operation of the braking apparatus 42 based on the generating factor (such as factors 1 to 9) for the deceleration request of the vehicle. When the deceleration request of the vehicle is generated, the braking restriction determining unit 17 determines whether to perform braking of the vehicle based on the deceleration request, based on the restricted mode and the generating factor for the deceleration request.

As a result of the vehicle control apparatus 10, automatic braking control can be implemented in which the braking apparatus 42 can be operated with certainty when the generating factor for the deceleration request of the vehicle is content that highly necessitates operation of the braking apparatus 42, while decrease in the durability of the braking apparatus 42 is suppressed by operation of the braking apparatus 42 being restricted. As a result, the vehicle control apparatus 10 that is highly safe and capable of implementing automatic braking control that takes into consideration the durability of the braking apparatus 42 can be provided.

The mode setting unit 19 may set one of a plurality of restricted modes of which the correspondence between the generating factors for the deceleration request of the vehicle and whether operation of the braking apparatus 42 can be performed differs. In this case, the mode setting unit 19 is preferably configured to set the restricted mode that is selected from the plurality of restricted modes based on a comparison between a predetermined parameter that affects the durability of the braking apparatus 42 and a predetermined mode setting threshold that is set for the parameter. For example, operation of the braking apparatus 42 can be prevented from being restricted even in stricter restricted modes as the generating factor becomes that which has a greater risk of leading to collisions and accidents, among the generating factors. Automatic braking control can be more appropriately implemented in which the braking apparatus 42 can be operated with certainty when the generating factor for the deceleration request of the vehicle is content that highly necessitates operation of the braking apparatus 42, while decrease in the durability of the braking apparatus 42 is suppressed by operation of the braking apparatus 42 being restricted.

The vehicle control apparatus 10 may be configured such that, when the durability determining unit 18 determines that the durability of the braking apparatus 42 has decreased, the driver of the vehicle is notified that the durability of the braking apparatus 42 has decreased and the driver is suggested to stop the vehicle. Safety of the vehicle can be ensured if the driver stops the vehicle before the deceleration request caused by a generating factor that highly necessitates operation of the braking apparatus 42 is generated, as a result of the notification and suggestion. Consequently, the vehicle control apparatus 10 that is highly safe and is capable of implementing automatic braking control that takes into consideration the durability of the braking apparatus can be provided.

The control unit and the method thereof described in the present disclosure may be implemented by a dedicated computer that is provided such as to be configured by a processor and a memory, the processor being programmed to provide one or a plurality of functions that are realized by a computer program. Alternatively, the control unit and the method thereof described in the present disclosure may be implemented by a dedicated computer that is provided by a processor being configured by a single dedicated hardware logic circuit or more. Still alternatively, the control unit and the method thereof described in the present disclosure may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory computer-readable (tangible) storage medium that can be read by a computer as instructions performed by the computer.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

Characteristic configurations extracted from the embodiments described above are described hereafter.

### [Configuration 1]

A vehicle control apparatus (10) that performs automatic braking control of a braking apparatus of a vehicle, the vehicle control apparatus comprising:
a braking restriction determining unit (17) that has a durability determining unit (18) that determines durability of the braking apparatus and a mode setting unit (19) that sets a control mode of automatic braking control to a restricted mode in which operation of the braking apparatus is restricted in response to the durability determining unit determining that the durability of the braking apparatus has decreased, wherein
the restricted mode restricts execution of operation of the braking apparatus based on a generating factor for a deceleration request of the vehicle, and
the braking restriction determining unit determines whether to perform braking of the vehicle based on the deceleration request, based on the restricted mode and the generating factor for the deceleration request, in response to the deceleration request of the vehicle being generated.

### [Configuration 2]

The vehicle control apparatus according to configuration 1,wherein:
the mode setting unit
   sets one of a plurality of restricted modes of which correspondence between the generating factors for the deceleration request of the vehicle and whether operation of the braking apparatus can be performed differs, and
   sets the restricted mode selected from the plurality of restricted modes based on a comparison between a predetermined parameter that affects the durability of the braking apparatus and a predetermined mode setting threshold that is set for the parameter.

### [Configuration 3]

The vehicle control apparatus according to configuration 1 or 2, wherein:
the generating factor for the deceleration request includes a factor for avoiding or mitigating a collision with an obstacle ahead of the vehicle.

### [Configuration 4]

The vehicle control apparatus according to any of configurations 1 to 3, wherein:
the generating factor for the deceleration request includes a factor for avoiding or mitigating collisions or maintaining inter-vehicle distances to a preceding vehicle and an adjacent vehicle of the vehicle.

### [Configuration 5]

The vehicle control apparatus according to any of configurations 1 to 4, wherein:
the generating factor for the deceleration request includes a factor for avoiding or mitigating a collision with a pedestrian.

### [Configuration 6]

The vehicle control apparatus according to any of configurations 1 to 5, wherein:
the generating factor for the deceleration request includes a factor for avoiding or mitigating a collision on a curved road.

### [Configuration 7]

The vehicle control apparatus according to any of configurations 1 to 6, wherein:
the generating factor for the deceleration request includes a factor for stopping or reducing vehicle speed in response to a stop instruction from a traffic signal.

### [Configuration 8]

The vehicle control apparatus according to any of configurations 1 to 7, wherein:
the generating factor for the deceleration request includes a factor for accommodating a vehicle speed on a regulatory sign or stopping in response to a speed regulatory sign or a stop instruction sign.

### [Configuration 9]

The vehicle control apparatus according to any of configurations 1 to 8, wherein:
the generating factor for the deceleration request includes a factor for reducing vehicle speed in response to a downhill road or road surface conditions.

### [Configuration 10]

The vehicle control apparatus according to any of configurations 1 to 9, wherein:
the generating factor for the deceleration request includes a factor for reducing vehicle speed in response to vehicle speed control by cruise control.

### [Configuration 11]

The vehicle control apparatus according to any of configurations 1 to 10, wherein:
the mode setting unit notifies a driver of the vehicle that the restricted mode is set.

### [Configuration 12]

The vehicle control apparatus according to any of configurations 1 to 11, wherein:
the driver of the vehicle is notified that the durability of the braking apparatus has decreased and the driver is suggested to stop the vehicle in response to the durability determining unit determining that the durability of the braking apparatus has decreased.

### [Configuration 13]

A vehicle control apparatus (10) that performs automatic braking control of a braking apparatus of a vehicle, the vehicle control apparatus comprising:
a durability determining unit (18) that determines durability of the braking apparatus, wherein
a driver of the vehicle is notified that the durability of the braking apparatus has decreased and the driver is suggested to stop the vehicle in response to the durability determining unit determining that the durability of the braking apparatus has decreased.

What is claimed is:

1. A vehicle control apparatus that performs automatic braking control of a braking apparatus of a vehicle, the vehicle control apparatus comprising:
a braking restriction determining unit that has a durability determining unit that determines durability of the braking apparatus and a mode setting unit that sets a control mode of automatic braking control to a restricted mode in which operation of the braking apparatus is restricted in response to the durability determining unit determining that the durability of the braking apparatus has decreased, wherein
the restricted mode restricts execution of operation of the braking apparatus based on a generating factor for a deceleration request of the vehicle, and
the braking restriction determining unit determines whether to perform braking of the vehicle based on the deceleration request, based on the restricted mode and the generating factor for the deceleration request, in response to the deceleration request of the vehicle being generated.

2. The vehicle control apparatus according to claim 1, wherein:
the mode setting unit
sets one of a plurality of restricted modes of which correspondence between the generating factors for the deceleration request of the vehicle and whether operation of the braking apparatus can be performed differs, and
sets the restricted mode selected from the plurality of restricted modes based on a comparison between a predetermined parameter that affects the durability of the braking apparatus and a predetermined mode setting threshold that is set for the parameter.

3. The vehicle control apparatus according to claim 1, wherein:
the generating factor for the deceleration request includes a factor for avoiding or mitigating a collision with an obstacle ahead of the vehicle.

4. The vehicle control apparatus according to claim 1, wherein:
the generating factor for the deceleration request includes a factor for avoiding or mitigating collisions or maintaining inter-vehicle distances to a preceding vehicle and an adjacent vehicle of the vehicle.

5. The vehicle control apparatus according to claim 1, wherein:
the generating factor for the deceleration request includes a factor for avoiding or mitigating a collision with a pedestrian.

6. The vehicle control apparatus according to claim 1, wherein:
the generating factor for the deceleration request includes a factor for avoiding or mitigating a collision on a curved road.

7. The vehicle control apparatus according to claim 1, wherein:
the generating factor for the deceleration request includes a factor for stopping or reducing vehicle speed in response to a stop instruction from a traffic signal.

8. The vehicle control apparatus according to claim 1, wherein:
the generating factor for the deceleration request includes a factor for accommodating a vehicle speed on a regulatory sign or stopping in response to a speed regulatory sign or a stop instruction sign.

9. The vehicle control apparatus according to claim 1, wherein:
the generating factor for the deceleration request includes a factor for reducing vehicle speed in response to a downhill road or road surface conditions.

10. The vehicle control apparatus according to claim 1, wherein:
the generating factor for the deceleration request includes a factor for reducing vehicle speed in response to vehicle speed control by cruise control.

11. The vehicle control apparatus according to claim 1, wherein:
the mode setting unit notifies a driver of the vehicle that the restricted mode is set.

12. The vehicle control apparatus according to claim 1, wherein:
the driver of the vehicle is notified that the durability of the braking apparatus has decreased and the driver is suggested to stop the vehicle in response to the durability determining unit determining that the durability of the braking apparatus has decreased.

13. A vehicle control apparatus that performs automatic braking control of a braking apparatus of a vehicle, the vehicle control apparatus comprising:
a processor;
a non-transitory computer-readable storage medium; and
a set of computer-executable instructions stored on the computer-readable storage medium that, when read and executed by the processor, cause the processor to implement:
determining durability of the braking apparatus; and
setting a control mode of automatic braking control to a restricted mode in which operation of the braking apparatus is restricted in response to determining that the durability of the braking apparatus has decreased, wherein
the restricted mode restricts execution of operation of the braking apparatus based on a generating factor for a deceleration request of the vehicle, and
determining the durability of the braking apparatus comprises:
determining whether to perform braking of the vehicle based on the deceleration request, based on the restricted mode and the generating factor for the deceleration request, in response to the deceleration request of the vehicle being generated.

14. A vehicle control method for performing automatic braking control of a braking apparatus of a vehicle, the vehicle control method comprising:
determining durability of the braking apparatus; and
setting a control mode of automatic braking control to a restricted mode in which operation of the braking apparatus is restricted in response to determining that the durability of the braking apparatus has decreased, wherein
the restricted mode restricts execution of operation of the braking apparatus based on a generating factor for a deceleration request of the vehicle, and
determining the durability of the braking apparatus comprises:
determining whether to perform braking of the vehicle based on the deceleration request, based on the restricted mode and the generating factor for the deceleration request, in response to the deceleration request of the vehicle being generated.
